(19) United States
(12) Patent Application Publication
(10) Pub. No.: US 2026/0187789 A1
(43) Pub. Date: Jul. 2, 2026

(54) METHOD AND SYSTEM FOR PROVIDING A FAST SUB-PIXEL ACCURATE ALIGNMENT OF AN IMAGE OF AN OBJECT COMPRISING INTEGRATED CIRCUIT PATTERNS WITH A REFERENCE IMAGE

(71) Applicant: Carl Zeiss SMT GmbH, Oberkochen (DE)

(72) Inventors: Bjoern Froehlich, Jena (DE); Jan Tusch, Genthin (DE); Michael Niebisch, Jena (DE); Bjoern Brauer, Magstadt (DE); Alexander Freytag, Erfurt (DE); Mario Kanka, Jena (DE); Niklas Georg, Haiger (DE); Martin van Driel, Muenchen (DE); Thomas Pekin, Berlin (DE)

(21) Appl. No.: 19/430,987

(22) Filed: Dec. 23, 2025

(30) Foreign Application Priority Data
Dec. 30, 2024 (DE) 102024139922.8

(51) Int. Cl. G06T 7/00; G06T 7/32

(52) U.S. Cl. CPC G06T 7/001; G06T 7/32; G06T 2207/30148

(57) ABSTRACT

The invention relates to a computer implemented method for providing a fast sub-pixel alignment of an image of an object comprising integrated circuit patterns with a reference image, the method comprising: defining a search space comprising potential displacements between the image of the object and the reference image, wherein the search space depends on a preliminary alignment accuracy and a desired sub-pixel alignment accuracy; aligning the image of the object with the reference image by finding a potential displacement between the image of the object and the reference image within the search space that optimizes an alignment accuracy measure. The invention further relates to a corresponding system.

### CROSS-REFERENCE TO RELATED APPLICATION

This application claims benefit of German patent application No. 10 2024 139922.8, filed on Dec. 30, 2024, which is hereby incorporated by reference in its entirety.

### TECHNICAL FIELD

The invention relates to systems and methods for providing a fast sub-pixel accurate alignment of an image of an object comprising integrated circuit patterns with a reference image, more specifically to a computer implemented method, a computer-readable medium, a computer program product and a corresponding system. The method, computer-readable medium, computer program product and system can be utilized for quantitative metrology, process monitoring, defect detection and defect review in objects comprising integrated circuit patterns, e.g., in photolithography masks, reticles or wafers.

### BACKGROUND

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example, 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus variation, etc.

Photolithography mask inspection needs to be done at multiple points in time in order to improve the quality of the photolithography masks and to maximize their usage cycles. Once the photolithography mask is fabricated according to the requirements, an initial quality assessment of the photolithography mask is done at the mask house before it is shipped to the wafer fab. Semiconductor device design and photolithography mask manufacturing quality are verified by different procedures before the photolithography mask enters a semiconductor fabrication facility to begin production of integrated circuits. The semiconductor device design is checked by software simulation to verify that all features print correctly after photolithography in manufacturing. The photolithography mask is inspected for defects and measured to ensure that the features are within specification. The data gathered during this process becomes the golden baseline or reference for further inspections to be performed at the mask house or wafer fab. Any defects found on the photolithography mask are validated using a mask qualification system followed by a decision of sending the photolithography mask for repair or decommissioning the mask and ordering a new one. At the wafer fab, the photolithography mask is scanned to find additional defects called “adders” compared to the last scan performed at the mask house. Each of these adders is analyzed using a mask qualification system. In case of a particle defect, the particle is removed. In case of a pattern-based defect the photolithography mask is either repaired, if possible, or replaced by a new one. The inspection process is repeated after every few photolithography cycles.

Each defect in the photolithography mask can lead to unwanted behavior of the produced wafer, or a wafer can be significantly damaged. Therefore, each defect must be found and repaired if possible and necessary. Reliable and fast defect detection methods are, therefore, important for photolithography masks.

Apart from defect detection in photolithography masks, defect detection in wafers is also crucial for quality management. During the manufacturing of wafers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition, etc. Therefore, a quality assurance process and a quality control process are important for ensuring high quality standards of the manufactured wafers.

Apart from quality assurance and quality control, defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus variation, etc., with different dies of the wafer being exposed to different manufacturing conditions. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment. Reliable and fast defect detection methods are, therefore, important for objects comprising integrated circuit patterns.

Defect detection methods usually rely on a process that compares an acquired image of the object comprising integrated circuit patterns to some kind of reference image, e.g., a golden reference, a design, a defect-free image or another image of the same structures. In order to obtain meaningful defect detection results, the acquired image has to be aligned with the reference image. In particular, in case defects are detected based on a simple difference image between the acquired image and the reference image, image alignment is indispensable. Without an accurate image alignment, the probability of detecting a defect is reduced, while the false positive defect detection rate is increased. Deviations due to misalignment occur especially at structure boundaries that often even dominate real defects. At the same time, structure boundaries are of particular interest in defect detection. Therefore, defect detection methods usually assume well-aligned images.

Classic methods for image alignment usually rely on finding fiducials in the image and the reference image to align both images based on the fiducials. However, such methods can only be used for a rough alignment of the images. They are not suitable for sub-pixel accurate alignments. Non-rigid registration methods produce sub-pixel accurate alignments. However, they require long computation times, and, in case of machine learning methods, training data and training time.

For mask inspection, however, highly accurate and extremely fast image alignment methods are required to fulfill the high standards of accuracy and throughput in this industry sector.

It is, therefore, a general aspect of the invention to provide a sub-pixel alignment of an image of an object comprising integrated circuit patterns with a reference image that requires very low computation times. An aspect of the invention is to improve the accuracy of the alignment. Another aspect of the invention is to reduce the memory resources required for aligning the image to the reference image.

The aspects are achieved by the invention specified in the independent claims. Advantageous embodiments and further developments of the invention are specified in the dependent claims.

### SUMMARY

Embodiments of the invention concern computer implemented methods, computer-readable media and systems for aligning an image of an object comprising integrated circuit patterns with a reference image and for detecting defects in an image of an object comprising integrated circuit patterns.

The invention involves, according to a first embodiment, a computer implemented method for providing a fast sub-pixel alignment of an image of an object comprising integrated circuit patterns with a reference image, the method comprising: a. Defining a search space comprising potential displacements between the image of the object and the reference image, wherein the search space depends on a preliminary alignment accuracy and a desired sub-pixel alignment accuracy; b. Aligning the image of the object with the reference image by finding a potential displacement between the image of the object and the reference image within the search space that optimizes an alignment accuracy measure.

By exploiting prior knowledge of the alignment, e.g., the preliminary alignment accuracy, the desired alignment accuracy or noise frequency bands, user input or machine properties, the search space can be defined and searched very efficiently to reduce the computation time and still obtain an alignment of the desired sub-pixel accuracy.

The alignment can be a rigid alignment that aligns the image of the object with the reference image using only displacements within the dimensions of the images.

An integrated circuit pattern can, for example, comprise semiconductor structures. An object comprising integrated circuit patterns can refer, for example, to a photolithography mask, a reticle or a wafer. In a photolithography mask or reticle the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

The object comprising integrated circuit patterns may be a photolithography mask. The photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

An image is aligned with a reference image at an alignment accuracy if the deviation of the locations of the structures in the image and the locations of the corresponding structures in the reference image is less than or equal to the alignment accuracy. An alignment accuracy can be used as a synonym for maximum alignment error. The alignment is accomplished by applying, e.g., rigid transformations to the image. Using prior knowledge, e.g., of the system used to acquire the image of the object and/or the reference image, the rigid transformations can be limited to specific types of rigid transformations, for example to displacements in case rotations do not occur.

An alignment accuracy can be measured in pixels, i.e., the number of pixels the location of the structures in the image maximally deviates from the location of the corresponding structures in the reference image. This deviation can, for example, be measured using a norm, e.g., an L2 or L1 norm, or different norms in each dimension. With decreasing maximum local pixel deviation the alignment accuracy increases. Thus, the lower the maximum pixel deviation the larger the alignment accuracy. A sub-pixel alignment accuracy refers to an alignment accuracy of less than one pixel. A preliminary alignment accuracy refers to an alignment accuracy of the image of the object and the reference image before carrying out the method steps. A desired sub-pixel alignment accuracy refers to the desired alignment accuracy after carrying out the method steps. The desired sub-pixel alignment accuracy is higher than the preliminary alignment accuracy. Thus, the maximum pixel deviation is larger before the alignment (preliminary alignment accuracy) than after the alignment (desired sub-pixel alignment accuracy).

The preliminary and/or the desired sub-pixel alignment accuracy can be indicated by a user, or they can be derived from properties of the system used to acquire the image of the object and/or the reference image, e.g., of an optical system, in particular of a mask inspection system. The preliminary alignment accuracy can be derived from a preliminary alignment that was carried out before. In an example, the preliminary alignment accuracy is above or equal to one pixel.

An alignment accuracy can be measured using an alignment accuracy measure. The alignment accuracy measure is optimized to find the most accurate alignment between the image of the object and the reference image.

An image of an object comprising integrated circuit patterns can refer to various kinds of images of the object, e.g., a two-dimensional image, a three-dimensional image, a stack of images or a volumetric three-dimensional image that can, for example, be processed slice by slice. An image can be acquired using an image acquisition system. An image acquisition system can comprise an optical system that acquired aerial images (e.g., a mask inspection system, an optical mask qualification system, a metrology systems, etc.), or a structured electron microscope (SEM), a focused-ion-beam (FIB) system, a FIB-SEM, an atomic force microscope (AFM), an x-ray system, an ultrasound system, etc. Images can, thus, be of various modalities, e.g., structured electron microscopy (SEM) images, aerial images, optical images, x-ray images, computer tomography (CT) images, focused-ion-beam (FIB) images, atomic force microscopy (AFM) images, ultrasound images or multimodal images, e.g., acquired using a combination of x-ray imaging and SEM.

An image can also be simulated, e.g., from a model of the object comprising integrated circuit patterns, e.g., from a design of a photolithography mask. A design of a photolithography mask refers to a representation of the photolithography mask or a section thereof. The design can, for example, comprise a computer readable file, such as a computer aided design (CAD) file or a graphic data system (GDS) file, or a technical drawing, a set of polygons representing the structures of the object, e.g., of the photolithography mask, or a section thereof. A design can comprise material information, e.g., complex refractive indices of materials contained in the photolithography mask, electric permittivities, magnetic permeabilities, or derived representations. A design of a photolithography mask can comprise parameters describing dimensions of structures in the photolithography mask, e.g., the thicknesses of the layers in the multilayer of an EUV mask.

An image of an object comprising integrated circuit patterns can image the complete object or one or more subsections thereof.

A reference image refers to an image of an object comprising integrated circuit patterns or to a section thereof, that represents at least approximately the same structures as the image of the object comprising integrated circuit patterns. The reference image can be of the same type as the image of the object or of a different type. The reference image can be acquired using an image acquisition system as described above, or it can be simulated from a model or design as described above. A reference image can comprise an acquired aerial image of the same object, e.g., at a different point in time, using a different image acquisition system, using the same image acquisition system with different settings, using a different section of the same object that contains at least approximately the same structures, etc. A reference image can comprise an acquired image of a different object comprising at least approximately the same structures as the image of the object. A reference image can comprise a so-called golden reference, e.g., an image of a defect-free object. A reference image can comprise a representation of the structures of the object, e.g., a design of a photolithography mask or a derived representation of a design. A reference image can also comprise a simulated image, e.g., a simulated aerial image.

An aerial image indicates the radiation intensity distribution of an optical system (e.g., photolithography system, inspection system, optical mask qualification system, metrology system) in a wafer plane for a given photolithography mask. It refers to the image that is formed by the projection of light, e.g., of EUV or DUV wavelength, through a photolithography mask onto an imaging sensor, e.g., charge coupled device (CCD) or complementary metal oxide semiconductor (CMOS) arrays. The aerial image, thus, represents the structures on the surface of a wafer when printing the wafer using the photolithography mask in the photolithography system. A wafer plane refers to a plane within the resist on top of the wafer in the photolithography system. The imaging sensor can be part of a camera adapted for acquiring images at predetermined wavelengths. The camera can be an EUV camera, and/or a camera comprising a TDI sensor. In preferred embodiments, an image acquisition method comprises the use of an EUV camera comprising a TDI sensor. The camera's image sensor can accordingly be an EUV image sensor, i.e., an image sensor that is sensitive to EUV light. EUV light is light in the extreme ultraviolet spectral range with wavelengths between 5 nm and 100 nm, in particular with wavelengths between 5 nm and 30 nm. Especially the EUV light can have a wavelength of 13.5 nm. The EUV camera can be adapted for use in a photolithography mask inspection system, wherein the photolithography mask is projected onto an EUV image sensor of the EUV camera. In preferred embodiments, the image acquisition method comprises illuminating a photolithography mask with actinic radiation within the EUV wavelength range. EUV radiation reflected from the mask is then projected on an imaging sensor of an EUV camera via accordingly adapted projection optics.

An aerial image can, for example, be generated by applying an optical system to a photolithography mask. An aerial image can also be simulated using a design of a photolithography mask and an aerial image simulation method.

An aerial image can be simulated from a design of a photolithography mask using aerial image simulation methods. For example, rigorous simulation methods such as finite difference time domain (FDTD) or rigorous coupled wave analysis (RCWA) can be used that are known to a person skilled in the art. Since they require long computation times, fast but less accurate approximations such as the thin element approximation (TEA) that relies on a thin mask assumption can be used. To obtain fast and accurate results, simulation methods that are based on physical models but still do not rely on the thin mask assumption can be used, e.g., the one disclosed in WO 2024 141484 A1 and in DE 10 2022 135 019 A1, the entire contents of the above applications are incorporated by reference. Apart from physical simulations, trained machine learning models can be used to simulate aerial images from designs.

An aerial image can refer to the aerial image of a complete photolithography mask, or it can refer to the aerial image of a section of the photolithography mask.

According to a second embodiment of the invention, the alignment accuracy measure evaluates the alignment accuracy between a displaced image for a potential displacement within the search space and the reference image, and the displaced image is computed by defining a corresponding convolution kernel that realizes the potential displacement of the image of the object and by convolving the image of the object with the convolution kernel, or the alignment accuracy measure evaluates the alignment accuracy between a displaced image for a potential displacement within the search space and the image of the object, and the displaced image is computed by defining a corresponding convolution kernel that realizes the potential displacement of the reference image and by convolving the reference image with the convolution kernel.

Thus, according to the second embodiment of the invention, a computer implemented method for providing a fast sub-pixel alignment of an image of an object comprising integrated circuit patterns with a reference image comprises the following steps: defining a search space of potential displacements between the image of the object and the reference image, wherein the search space depends on a preliminary alignment accuracy and a desired sub-pixel alignment accuracy; for each of the potential displacements within the search space: either applying the potential displacement to the image of the object to obtain a displaced image, and aligning the image of the object and the reference image by selecting the potential displacement that optimizes an alignment accuracy measure between the displaced image and the reference image, or applying the potential displacement to the reference image to obtain a displaced image, and aligning the image of the object and the reference image by selecting the potential displacement that optimizes an alignment accuracy measure between the image of the object and the displaced image. The method, in particular the computation of the displaced images, can at least partially be carried out using one or more hardware acceleration devices to reduce the computation time.

The potential displacement can, thus, define a displacement of the image of the object yielding a displaced image that is afterwards compared to the reference image, or the potential displacement can define a displacement of the reference image yielding a displaced image that is afterwards compared to the image of the object.

By specifying the search space and computing each of the displaced images, the method can be easily parallelized, and the computations can be carried out on one or more hardware acceleration devices. In this way, the computation time is reduced.

Hardware acceleration devices include, but are not limited to, graphics processing units (GPUs), tensor processing units (TPUs), field programmable gate arrays (FPGAs) and application specific integrated circuits (ASICs).

By computing the displacements using convolutions, in particular in frequency space, the computation time can be reduced.

According to an aspect, the size of the convolution kernel depends on the preliminary alignment accuracy. In this way, the size of the convolution kernel is restricted, which leads to lower computation times.

According to another aspect, at least one convolution kernel is separated into lower dimensional convolution kernels, and the corresponding displaced image is obtained by convolving the image of the object or the reference image successively with the lower dimensional convolution kernels. By separating convolution kernels into lower dimensional convolution kernels, the convolutions can be carried out in parallel, which strongly reduced the computation time.

According to an example of the second embodiment, the potential displacements form a regular grid in the search space. The regular grid can, for example, be defined using the preliminary alignment accuracy and the desired sub-pixel alignment accuracy. In this way, the search space can be covered with a small number of potential displacements that nevertheless fulfill the desired sub-pixel alignment accuracy. The potential displacements can be limited by the preliminary alignment accuracy, as larger potential displacements are not required to fulfill the desired sub-pixel alignment accuracy.

In an example of the second embodiment, the number of potential displacements in the search space is inversely proportional to the desired sub-pixel alignment accuracy. In this way, the number of potential displacements in the search space is minimized and, thus, the computation time is reduced.

According to an example of the second embodiment, the displaced images are computed using one or more hardware acceleration devices. Since the displaced images can be computed independently of one another, they can be computed in parallel. In this way, the computation time is reduced.

According to a third embodiment of the invention, the alignment accuracy measure comprises a cross-correlation between the image of the object and the reference image.

According to an example of the third embodiment of the invention, a computer implemented method for providing a fast sub-pixel accurate alignment of an image of an object comprising integrated circuit patterns and a reference image comprises: obtaining a preliminary alignment between the image and the reference image by finding a maximum of a cross-correlation of the image and the reference image using a fast Fourier transform; defining a search space of potential displacements between the image of the object and the reference image using the maximum of the cross-correlation; and aligning the image of the object with the reference image with sub-pixel alignment accuracy by computing a maximum of an upsampled cross-correlation between the image and the reference image within the search space using a matrix-multiply discrete Fourier transform.

Instead of explicitly computing the displaced images, a preliminary alignment accuracy measure in form of a cross-correlation is directly computed in frequency space for all potential displacements. To refine the pixel-accurate alignment to sub-pixel accuracy, a search space is defined, and the alignment accuracy measure is only computed within this search space. To achieve the desired sub-pixel alignment accuracy, the search space is upsampled. The FFT, however, is restricted to computing the cross-correlation for the entire upsampled image and reference image. By using a matrix-multiply discrete Fourier transform, the cross-correlation can be computed in frequency space only within the search space. In this way, the computation time and required memory is strongly reduced.

The alignment accuracy measure can comprise a weighted spectral cross-correlation. A weighted spectral cross-correlation refers to a cross-correlation that is computed in frequency space and that applies weighting factors to different frequencies. Without weighting, the intensity distribution of the image and the reference image is fully taken into account leading to a large weight put into low spatial frequency signals, resulting in a center-of-mass like registration between the image and the reference image. Using weighting factors for different frequencies allows for weighting of long range slowly varying intensity versus high frequency edges or noise. Thus, a higher accuracy of the alignment can be achieved.

In an example, the weighted spectral cross-correlation is weighted with the inverse of its magnitude to the power of a value within the interval [0,1]. The value between 0 and 1 determines the influence of image intensity on the correlation result. In case of 0, the standard cross-correlation with a high influence of image intensity is computed. In case of 1, a phase correlation is computed that does not consider image intensity at all. Values between 0 and 1 can be selected as a compromise between standard cross-correlation and phase correlation. The power n allows for weighting of long range slowly varying intensities versus high frequency edges or noise. In this way, the computation of the cross-correlation can take into account the contents of the image, e.g., the type of structures in the object, thus improving the alignment accuracy.

In an example, the alignment accuracy measure comprises a phase correlation. A phase correlation is a type of cross-correlation that relies on phase information only, e.g., on edges and structures instead of intensity. Depending on the contents of the image, a phase correlation can improve the alignment accuracy, since specifically edge and structure locations determine the alignment accuracy measure.

The FFT and DFT that can be used to compute the alignment accuracy measure in form of the cross-correlation can be computed using one or more hardware acceleration devices to reduce the computation time.

The computation time can be further reduced in any of the embodiments described above using the following steps:

According to an example of the first, second or third embodiment of the invention, the optimum of the alignment accuracy measure is refined by fitting a function to the alignment accuracy measure and determining its optimum. The function can, for example, be a parabolic function. In this way, the accuracy of the alignment is improved.

In an example of the first, second or third embodiment, the computation of the alignment accuracy measure is restricted to non-homogeneous sections of the image of the object. In this way, the accuracy of the alignment is improved and the computation time is reduced.

According to an example of the first, second or third embodiment, the preliminary alignment accuracy and the search space in step a. are defined with respect to a preliminary alignment of the image of the object and the reference image. In this way, a limited search space can be defined for the sub-pixel accurate alignment, thereby reducing the computation time.

In an example of the first, second or third embodiment, the preliminary alignment accuracy is one pixel. Thus, the preliminary alignment is used to obtain a fast pixel-accurate alignment in order to define a suitable search space, and the minimization of the alignment accuracy measure within the search space is used to obtain a sub-pixel accurate alignment. In this way, the computation time is reduced.

In an example of the first, second or third embodiment, the preliminary alignment is obtained by maximizing a cross-correlation that is obtained by applying an inverse fast Fourier transform to a Hermitian product of the image spectrum and the reference spectrum. By using an FFT the computation time is reduced.

According to an example of the first, second or third embodiment, a coarse-to-fine image alignment is realized by iterating the method steps for a sequence of increasing alignment accuracies ending with the desired sub-pixel alignment accuracy. By iteratively increasing the alignment accuracy, the search space is limited in each step and, thus, the required memory resources as well. This is particularly beneficial, if the required convolutions cannot be carried out in parallel due to limited memory resources. By using a coarse-to-fine image alignment scheme, the method takes into account limited memory resources of the system.

In case the preliminary alignment accuracy is above one pixel, the sequence of increasing alignment accuracies can consist of two consecutive sections, wherein the first section consists of one or more integer values and the second section consists of one or more sub-pixel values. In particular, the sequence of increasing alignment accuracies can contain an alignment accuracy of one pixel. In this way, first one or more coarse alignments with an accuracy of one or more pixels are carried out followed by one or more fine alignments with a sub-pixel accuracy. Thus, memory resources are reduced.

According to an example of the first, second or third embodiment, the method further comprises denoising the image of the object. In this way, noise components are filtered from the image and do not influence the alignment. Thus, the accuracy of the alignment is improved.

According to an aspect, the image of the object is acquired by an optical system, in particular by a mask inspection system, and pure noise components are filtered from the spectrum of the image of the object and from the spectrum of the reference image using prior knowledge about the imaging settings of the optical system, in particular of the mask inspection system. The imaging settings of the optical system, in particular of the mask inspection system, comprise, for example, one or more of the group comprising the physical shape of the imaging aperture, the intensity spectrum of the incoming light, the numerical aperture of the optical system, in particular of the mask inspection system, the pixel size. In this way, prior knowledge about the optical system, in particular of the mask inspection system, can be used to remove noise from the image of the object and from the reference image, thereby improving the alignment accuracy.

In an example, the image of the object is acquired by an optical system, and prior knowledge about the optical system is used to limit the search space. In this way, the accuracy of the alignment is improved, and the computation time of the method is reduced.

A method for detecting defects in an image of an object comprising integrated circuit patterns according to a fourth embodiment of the invention comprises: aligning the image of the object with a reference image using a method according to any one of the preceding claims; and computationally comparing the aligned image of the object with the reference image and marking deviations as defects.

Computationally comparing the aligned image of the object with the reference image means that the aligned image of the object and the reference image are compared algorithmically and automatically, e.g., by computing a difference image or by applying a machine learning model for defect detection.

The term “defect” refers to a localized deviation of an object comprising integrated circuit patterns from an a priori defined norm of the object. The norm of the object can be defined by one or more corresponding reference objects or reference datasets, e.g., by design datasets, simulated datasets or acquired defect-free datasets. For instance, a defect of an object comprising integrated circuit patterns can result in malfunctioning of a printed wafer and, thus, of a complete associated semiconductor device. Depending on the detected defect, objects comprising integrated circuit patterns can for example, be evaluated, repaired or discarded.

In order to save computation time and resources, the method for detecting defects can further comprise determining a defect likelihood for a defect being present in the image of the object using the alignment accuracy measure, and, in case the defect likelihood is below a threshold, skipping step ii.)

According to an example of the fourth embodiment, the method for detecting defects further comprises controlling at least one object manufacturing process parameter based on one or more measurements of the defects. Based on measurements of the detected defects, e.g., the type, the size, the dimension, etc., process parameters of the manufacturing process such as, for example, exposure time, focus, etching or deposition parameters can be modified to prevent defects in further manufactured objects.

According to an example of the fourth embodiment, the method further comprises modifying the object to at least one of reduce, repair, or remove at least one defect. In this way, defects in manufactured objects are reduced to improve their quality.

A computer-readable medium according to a fifth embodiment of the invention stores a computer program executable by a computing device, the computer program comprising code for executing a method for aligning an image of an object comprising integrated circuit patterns with a reference image according to the first, second or third embodiment of the invention.

A computer program product according to a sixth embodiment of the invention comprises instructions which, when the program is executed by a computer, cause the computer to carry out a method for aligning an image of an object comprising integrated circuit patterns with a reference image according to the first, second or third embodiment of the invention.

A system comprising according to a seventh embodiment of the invention comprises: an image acquisition system configured to provide an image of the object comprising integrated circuit patterns; one or more processing devices; and one or more machine-readable hardware storage devices comprising instructions that are executable by one or more processing devices to perform operations comprising the method for aligning an image of an object comprising integrated circuit patterns to a reference image according to the first, second or third embodiment and/or comprising the method for detecting defects in object comprising integrated circuit patterns according to the fourth embodiment.

The invention described by embodiments, examples and aspects is not limited to the embodiments, examples and aspects, but can be implemented by those skilled in the art by various combinations or modifications thereof.

### BRIEF DESCRIPTION OF DRAWINGS

FIG. 1 illustrates an exemplary transmission-based optical system, e.g., a deep ultraviolet (DUV) optical system;

FIG. 2 illustrates an exemplary reflection-based optical system, e.g., an extreme ultra-violet light (EUV) optical system;

FIG. 3 shows the computation of a difference image of an image of an object and a reference image without aligning the image of the object to the reference image;

FIG. 4 illustrates a flowchart of a method for aligning an image of an object comprising integrated circuit patterns with a reference image;

FIG. 5 illustrates a flowchart of a method for aligning an image of an object comprising integrated circuit patterns with a reference image according to a second embodiment;

FIG. 6 shows a search space for aligning an image of an object with a preliminary alignment accuracy p with a reference image with a desired sub-pixel accuracy d;

FIG. 7 illustrates the computation of an aligned image of an object using a method according to the first or second embodiment of the invention;

FIG. 8 illustrates a flowchart of a method for aligning an image of an object comprising integrated circuit patterns with a reference image according to a third embodiment;

FIG. 9 illustrates the computation of an aligned image of the object using a method according to the first or third embodiment of the invention;

FIG. 10 shows the computation of a difference image of an image of an object and a reference image after aligning the image of the object with the reference image;

FIG. 11 illustrates a U-Net that can be used for defect detection in a difference image; and

FIG. 12 illustrates a system according to a seventh embodiment of the invention.

### DETAILED DESCRIPTION

In the following, advantageous exemplary embodiments of the invention are described and schematically shown in the figures. Throughout the figures and the description, same reference numbers are used to describe same features or components.

An image of an object comprising integrated circuit patterns can refer to various kinds of images of the object, e.g., a two-dimensional image, a three-dimensional image, a stack of images or a volumetric three-dimensional image that can, for example, be processed slice by slice. Images can be of various modalities, e.g., structured electron microscopy (SEM) images, aerial images, optical images, x-ray images, computer tomography (CT) images, focused-ion-beam (FIB) images, atomic force microscopy (AFM) images, ultrasound images or multimodal images, e.g., acquired using a combination of x-ray imaging and SEM. An image of an object comprising integrated circuit patterns can comprise the complete object or one or more subsections thereof.

An aerial image can be acquired by a variety of optical systems 10, 10′, e.g., transmission-based optical systems or reflection-based optical systems such as EUV systems. An “optical system” refers to a system that uses light to inspect a photolithography mask. It illuminates the photolithography mask with light from an illumination source and projects the reflected or transmitted light from the photolithography mask surface to a wafer or to a camera sensor array. Optical systems comprise, for example, mask inspection systems, optical mask qualification systems and metrology systems.

A mask inspection system refers to an optical system used to detect defects in a photolithography mask by acquiring an aerial image of the photolithography mask. A mask inspection system can, for example, be a review system or a repair system. In particular, mask inspection systems comprise actinic photomask inspection systems. An optical mask qualification system refers to a system that is used to acquire an aerial image of a portion of a photolithography mask, thereby emulating settings of a photolithography system, e.g., illumination and imaging parameters. The acquired aerial image is of a higher quality than an aerial image acquired by an inspection system, e.g., of a reduced noise level. The portions of the photolithography mask can comprise potential defect locations detected using an inspection system for further review. The acquired aerial image can be used to examine the effect of a potential defect on a printed wafer, to verify that photolithography masks are defect-free, whether a repair attempt has been successful or for critical dimension estimation.

A metrology system refers to a system that is used to take measurements of structures in a photolithography mask by acquiring and analyzing an aerial image of the photolithography mask.

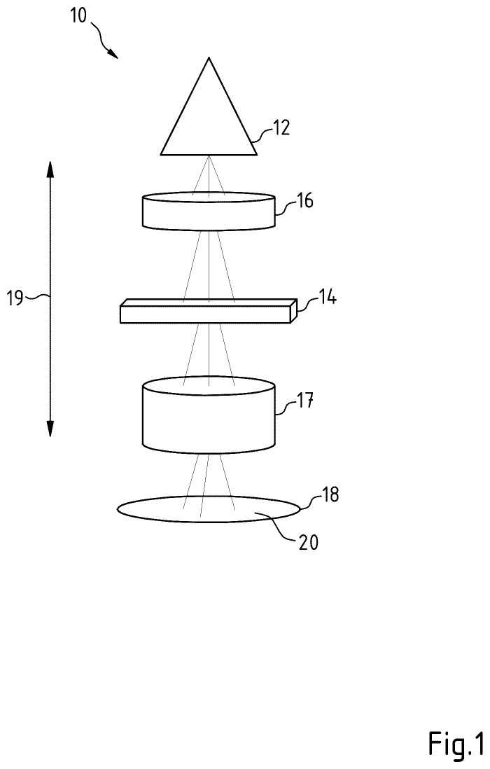

FIG. 1 illustrates an exemplary transmission-based optical system 10, e.g., a DUV inspection system. Major components are a light source 12, which may be a deep-ultraviolet (DUV) excimer laser source, imaging optics which, for example, define the partial coherence and which may include optics that shape radiation from the light source 12, a photolithography mask 14, illumination optics 16 that illuminate the photolithography mask 14 and projection optics 17 that project an image of the photolithography mask 14 onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(θₘₐₓ), wherein n is the refractive index of the media between the substrate and the last element of the projection optics 17, and θₘₐₓ is the largest angle of the beam exiting from the projection optics 17 that can still impinge on the wafer plane 18. The radiation distribution at the wafer plane 18 is imaged by an image sensor 20 of a camera to generate an aerial image. The optical system 10 can, for example, be equipped with a staring array sensor or a line-scanning sensor or a time-delayed integration (TDI) sensor.

In the present document, the terms “illumination”, “radiation” or “beam” are used to encompass all types of electromagnetic radiation, including ultraviolet radiation (e.g., with a wavelength of 365, 248, 193, 157 or 126 nm) and EUV (extreme ultra-violet radiation, e.g., having a wavelength in the range of about 3-100 nm).

Illumination optics 16 may include optical components for shaping, reducing and/or projecting radiation from the light source 12 before the radiation passes the photolithography mask 14. Projection optics 17 may include optical components for shaping, reducing and/or projecting the radiation after the radiation passes the photolithography mask 14. The illumination optics 16 exclude the light source 12, the projection optics exclude the photolithography mask 14.

Illumination optics 16 and projection optics 17 may comprise various types of optical systems, including refractive optics, reflective optics, apertures and catadioptric optics, for example. Illumination optics 16 and projection optics 17 may also include components operating according to any of these design types for directing, shaping or controlling the projection beam of radiation, collectively or singularly.

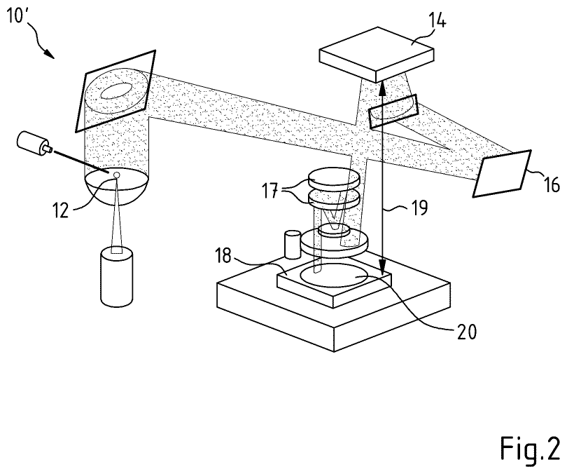

FIG. 2 illustrates an exemplary reflection-based optical system 10′, e.g., an extreme ultraviolet light (EUV) inspection system. Major components are a light source 12, which may be a laser plasma light source, illumination optics 16 which, for example, define the partial coherence and which may include optics that shape radiation from the light source 12, a photolithography mask 14, and projection optics 17 that project an image of the photolithography mask design onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(θₘₐₓ), wherein n is the refractive index of the media between the substrate and the last element of the projection optics 17, and θₘₐₓ is the largest angle of the beam exiting from the projection optics 17 that can still impinge on the wafer plane 18. The radiation distribution at the wafer plane 18 is imaged by an image sensor 20 of a camera to generate an aerial image. The optical system 10′ can, for example, be equipped with a staring array sensor or a line-scanning sensor or a time-delayed integration (TDI) sensor.

A reference image refers to an image that represents at least approximately the same structures as the image of the object comprising integrated circuit patterns. The reference image can be an aerial image or a different type of image such as a SEM image or a design image. A reference image can comprise an acquired image of the same object, e.g., at a different point in time, using a different image acquisition system (e.g., a different optical system), using the same image acquisition system (e.g., the same optical system) with different settings, using a different section of the same object that contains at least approximately the same structures, etc. A reference image can comprise an acquired image of a different object comprising at least approximately the same structures as the image of the object. A reference image can comprise a simulated image, e.g., a simulated aerial image. A reference image can comprise a so-called golden reference, e.g., an image of a defect-free object. A reference image can comprise a representation of the structures of the photolithography mask, e.g., a design of the photolithography mask or a derived representation of a design.

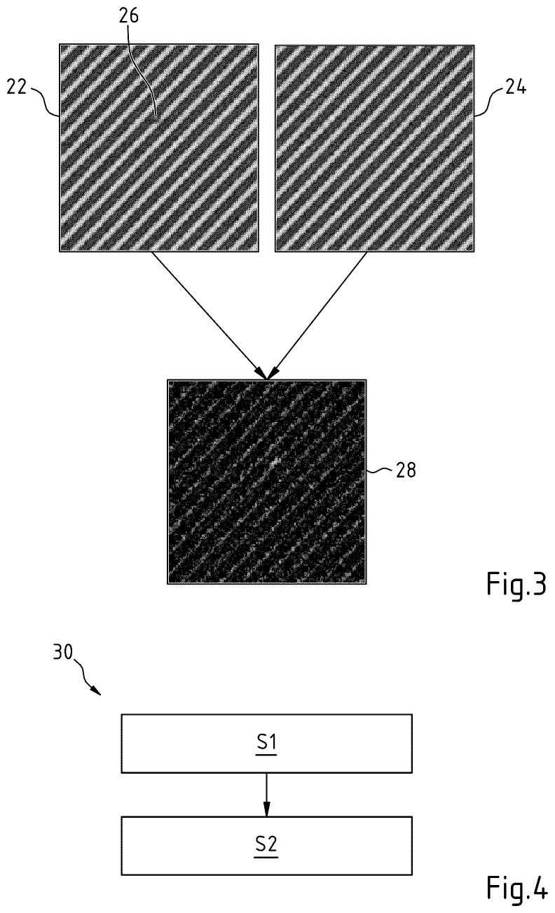

As illustrated in FIG. 3, defects 26 can be detected by comparing an image 22 of an object comprising integrated circuit patterns 14 to a reference image 24, for example, by computing a difference image 28. Large values in the difference image refer to defects 26, but also to misalignments between the image 22 and the reference image 24. Thus, to reliably detect defects without many false positives a highly accurate alignment of the image 22 and the reference image 24 is important. In this way, defects can be detected with a higher accuracy, and false positive defect detections are reduced. However, for mask inspection tasks very low computation times are required at the same time to fulfill the throughput requirements of the inspection systems for the large amounts of image data. Therefore, image alignment has to be carried out at very short computation times. Known alignment methods are either not sufficiently accurate (e.g., no sub-pixel accuracy) or require long computation times (e.g., registration methods or image alignment methods in frequency space).

To achieve highly accurate alignment results at very short computation times for images of objects comprising integrated circuit patterns, prior knowledge is exploited. The prior knowledge can, for example, comprise a preliminary alignment accuracy between the image and the reference image, a desired sub-pixel alignment accuracy and/or a limited number of alignment operations (e.g., only displacements are considered, no rotations). Therefore, a computer implemented method 30 for providing a fast sub-pixel alignment of an image of an object comprising integrated circuit patterns with a reference image according to a first embodiment as illustrated in FIG. 4 comprises the following steps S1 and S2: defining a search space comprising potential displacements between the image of the object and the reference image, wherein the search space depends on a preliminary alignment accuracy and a desired sub-pixel alignment accuracy in a step S1; aligning the image of the object with the reference image by finding a potential displacement between the image of the object and the reference image within the search space that optimizes an alignment accuracy measure in a step S2.

Using prior knowledge, i.e., the preliminary alignment accuracy and the desired sub-pixel alignment accuracy, a specific search space for displacements is defined that satisfies the accuracy requirements. Based on an alignment accuracy measure, the deviation between each displaced image and the reference image or between each displaced image and the image of the object is computed. The displacement corresponding to the highest alignment accuracy measure (with the lowest pixel deviation) is selected as an estimate of the true displacement, and/or the corresponding displaced image is selected as aligned image. The computation of the alignment accuracy measures can be carried out using one or more hardware acceleration devices. Due to the limited search space based on the prior knowledge and the parallelization of the computations the method requires only very low computation times.

An alignment accuracy measure is used to find the most accurate alignment between the image of the object and the reference image. An alignment accuracy measure can, for example, comprise a norm such as an Lₚ norm, e.g., an L₁ or L₂ norm, a mean squared error, a sum of absolute differences, a Huber loss, a cross-correlation, etc. To measure an alignment accuracy, the inverse of any of the norms can, for example, be used.

An optimum of the alignment accuracy measure can be found, for example, using gradient based optimization. The gradient can, for example, be computed using automatic differentiation. To obtain particularly accurate and fast alignments, a method according to the second or third embodiment as described in the following can be used.

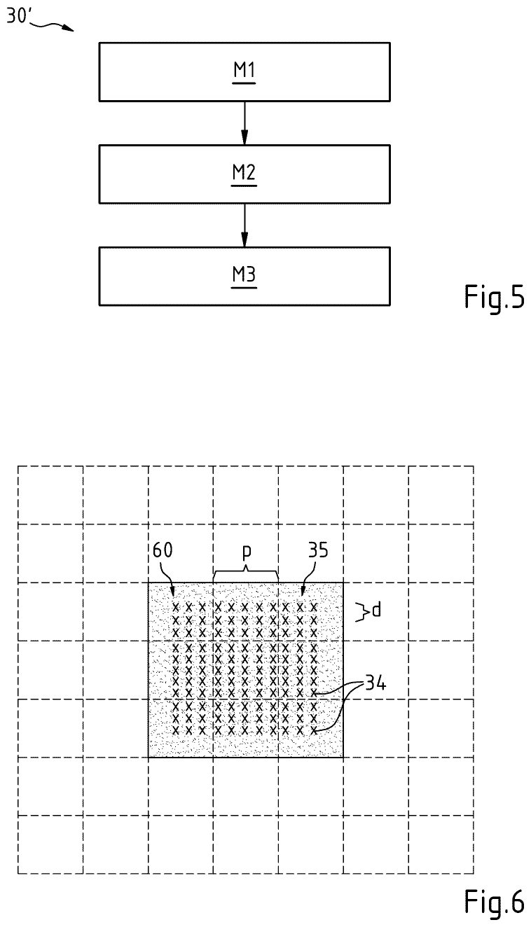

According to a second embodiment of the invention that is illustrated in FIG. 5, a computer implemented method 30′ for providing a fast sub-pixel alignment of an image of an object comprising integrated circuit patterns with a reference image comprises the following steps M1 to M3: defining a search space of potential displacements between the image of the object and the reference image, wherein the search space depends on a preliminary alignment accuracy and a desired sub-pixel alignment accuracy in a step M1; for each of the potential displacements within the search space, applying the potential displacement to the image of the object or to the reference image to obtain a displaced image in a step M2; and aligning the image of the object and the reference image by selecting the potential displacement that optimizes an alignment accuracy measure between the displaced image and the reference image or between the image of the object and the displaced image in a step M3. The computation of the displaced images can be carried out using one or more hardware acceleration devices to reduce the computation time.

The computation times for aligning the image and the reference image and, thus, also for defect detection, can be reduced by parallelization, e.g., by implementing the method on a GPU or TPU. As the different displacements and displaced images can be computed independently from one another, each of them can be computed in parallel. Thus, the computation time of the method is strongly reduced.

In an example of the second embodiment, the corresponding displaced image for a potential displacement within the search space is computed by defining a corresponding convolution kernel that realizes the potential displacement of the image of the object or the reference image and by convolving the image of the object with the convolution kernel.

Given an image of a preliminary alignment accuracy p (maximum prior pixel displacement) and a desired sub-pixel alignment accuracy of d (desired maximum posterior pixel displacement in each direction), a kernel size k×k for k=2┌p┐+1 is sufficient to cover all potential displacements. Thus, the kernel size depends on the preliminary alignment accuracy p. In case p is not integer valued, ┌p┐ refers to the next larger integer value. To obtain the desired sub-pixel alignment accuracy d, the number of potential displacements can be selected to form a regular grid in the search space. In this way, only a small number of potential displacements is required to fulfill the desired sub-pixel alignment accuracy. The number of potential displacements in horizontal and vertical direction of the regular grid is then

$$n = 2 \frac{1}{d} + 1.$$

Thus, the number of potential displacements in the search space is inversely proportional to the desired sub-pixel alignment accuracy. n·n potential displacements must be computed using a k×k kernel to obtain the desired sub-pixel alignment accuracy. The potential displacements are limited by the preliminary alignment accuracy. A padding of ┌p┐ is required at the boundaries of the image to apply the k×k kernel.

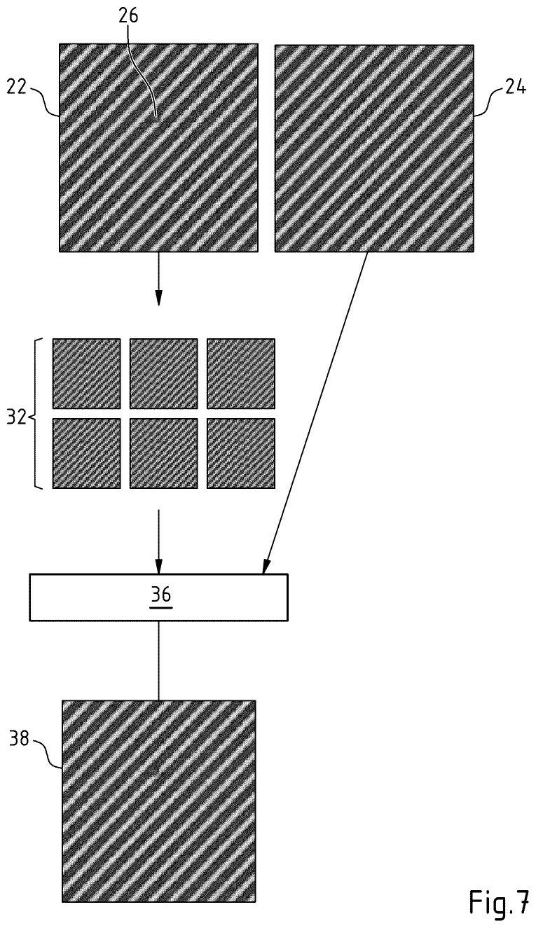

An example of the second embodiment illustrated in FIG. 6 shows a section of an image that is aligned with a reference image. Assuming a preliminary alignment accuracy of p=1 px and a desired sub-pixel alignment accuracy of d=0.2 px, a kernel of size 3×3 is sufficient to generate the potential displacements 34 of the image. The potential displacements form a regular grid. The number of potential displacements 34 is n·n=11·11=121. Thus, all potential displacements 34 required to obtain an alignment accuracy of 0.2 px can be expressed using 121 convolutions with a kernel of size 3×3. A padding of 1 px of the image is required.

A kernel to realize one of the displacements, e.g., the displacement of 0.2 px to the bottom and 0.4 px to the left, could be generated as follows:

$$[ \begin{matrix}0.2 \\ 0.8 \\ 0\end{matrix} ] \cdot [ \begin{matrix}0 & 0.6 & 0.4\end{matrix} ] = [ \begin{matrix}0 & 0.12 & 0.08 \\ 0 & 0.48 & 0.32 \\ 0 & 0 & 0\end{matrix} ]$$

Each displacement is computed by a convolution of the image with a kernel. The convolutions can be easily computed in parallel using one or more GPUs or TPUs to reduce computation time.

To further reduce the computation time of the alignment, at least one convolution kernel can be separated into lower dimensional convolution kernels, and the corresponding displaced image can be obtained by convolving the image of the object or the reference image successively with the lower dimensional convolution kernels. By separating a convolution kernel into lower dimensional convolution kernels that are successively applied to the image, the total number of operations is reduced. For example, the two-dimensional kernel above can be separated into two one-dimensional kernels that can be successively applied to the image of the object.

$$[ \begin{matrix}0 & 0.12 & 0.08 \\ 0 & 0.48 & 0.32 \\ 0 & 0 & 0\end{matrix} ] = [ \begin{matrix}0.2 \\ 0.8 \\ 0\end{matrix} ] \cdot [ \begin{matrix}0 & 0.6 & 0.4\end{matrix} ]$$

To compute the n·n convolutions, the image is first convolved with the n vertical kernels, and then the n results are convolved with the n horizontal kernels. In this way, the number of required operations is reduced from n·n·┌p┐·┌p┐ to n·┌p┐+n·n·┌p┐, e.g., from 11·11·3·3=1089 to 11·3+11·11·3=396 for the example above, which is a reduction by almost two thirds. The reduction factor increases with increasing values of the preliminary alignment accuracy p and the desired sub-pixel alignment accuracy d. Thus, the computation time is reduced. Here, again the convolutions with the lower dimensional kernels can be carried out in parallel for the vertical and the horizontal displacements to further reduce the computation time.

In case of a three-dimensional image of the object, the convolutions can be defined and applied accordingly. The kernels can then, for example, be separated into three lower dimensional kernels, e.g., a horizontal, a vertical and a depth kernel, yielding even larger reductions of the computation time.

As illustrated in FIG. 7, the image 22 of the object comprising integrated circuit patterns and the reference image 24 are aligned using the method 30 illustrated in FIG. 5. After computing displaced images 32 for each of the potential displacements 34 in the search space as described above, an alignment accuracy measure 36 for each of the displaced images 32 with respect to the reference image 24 or with respect to the image 22 of the object is computed. The alignment accuracy measure 36 can, for example, comprise an Lₚ norm, a mean squared error, a sum of absolute differences, a Huber loss, a cross-correlation, etc. The cross-correlation can be computed particularly fast using an FFT. The displaced image 32 with the highest alignment accuracy is then selected as aligned image 38.

According to a third embodiment of the invention, the alignment accuracy measure comprises a cross-correlation 54 between the image 22 of the object 88 and the reference image 24.

The alignment accuracy measure can comprise a weighted spectral cross-correlation. The weighted spectral cross-correlation can, for example, be weighted with the inverse of its magnitude to the power of a value within the interval [0,1]. Let I_{obj} indicate the image 22 of the object and I_{ref} the reference image 24 with discrete Fourier transforms i_{obj} and i_{ref}. Let further [symbol] denote the discrete Fourier transform, ⊗ the cross-correlation operation, * the complex conjugate, ∘ the element-wise product of two matrices and 1−n the power to which the Fourier coefficients are weighted. Then the weighted spectral cross-correlation can be written as

$$ℱ ( {I}_{obj} ⊗ {I}_{ref} ) \frac{{i}_{obj} ∘ {i}_{ref}^{*}}{{\vert {i}_{obj} ∘ {i}_{ref}^{*} \vert}^{n•}}$$

For n=0 we obtain the spectral cross-correlation without weighting. In this case the intensity distribution in the images is fully taken into account.

For n=1 the term

$${i}_{obj} ∘ {i}_{ref}^{*}$$

is normalized to unit magnitude, thereby only retaining the phase information. In this case, the alignment accuracy measure comprises a phase correlation. Both standard cross-correlation and phase-correlation can be seen as special cases of a weighted spectral cross-correlation, in which image intensity is weighted by a fraction n between 0 and 1. The power n, thus, determines the influence of image intensity on the cross-correlation result. In case the image of the object and the reference image differ in their intensities, a value of n close to or equal to 1 improves the alignment accuracy, since the alignment relies more on structure correlations, e.g., consistent edge locations. In case the intensities are similar, a value of n closer to 0 could improve the alignment accuracy, since the alignment considers image intensity and structure.

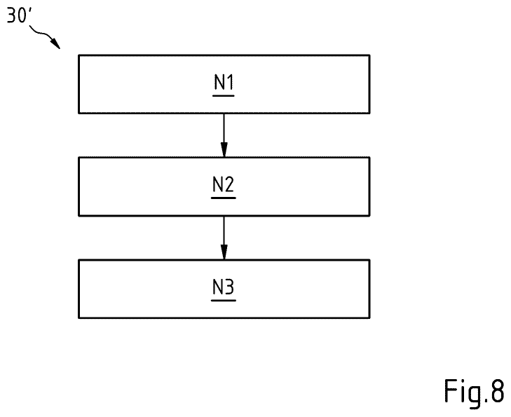

According to an example of the third embodiment of the invention illustrated in FIG. 8, a computer implemented method 30′ for providing a fast sub-pixel accurate alignment of an image of an object comprising integrated circuit patterns and a reference image comprises: obtaining a preliminary alignment between the image and the reference image by finding a maximum of a cross-correlation of the image and the reference image using a fast Fourier transform in a step N1; defining a search space of potential displacements between the image of the object and the reference image using the maximum of the cross-correlation in a step N2; and aligning the image of the object with the reference image with sub-pixel accuracy by computing a maximum of an upsampled cross-correlation between the image and the reference image within the search space using a matrix-multiply discrete Fourier transform in a step N3. The computation of the alignment accuracy measure can be carried out using one or more hardware acceleration devices to reduce the computation time.

Maximizing the cross-correlation is mathematically equivalent to minimizing the L2-norm of the difference image. However, the maximization of the cross-correlation can be implemented more efficiently to reduce the computation time. The cross-correlation is computed in frequency space, since the imaging aperture of the optical system used to acquire the image of the object acts a low pass filter. Usually, a pixel size below the Nyquist sampling criterion is used, such that the image of the object is a bandlimited Nyquist-limited function (up to the noise). The grid-based search based on DFT-upsampling is found to reduce the computation time compared to gradient-based optimization, based on numerical benchmark tests on an A100 GPU using batched computations. Additionally, it offers further advantages, as robustness (local minima do not pose a problem) as well as fixed runtime.

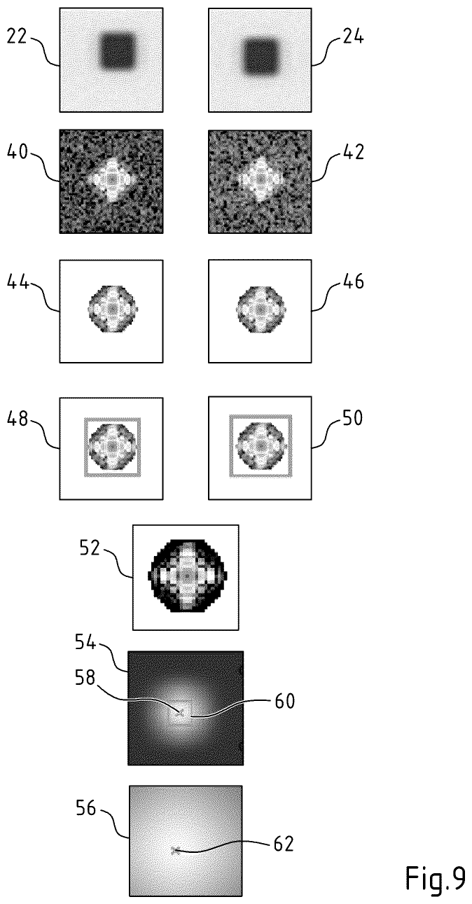

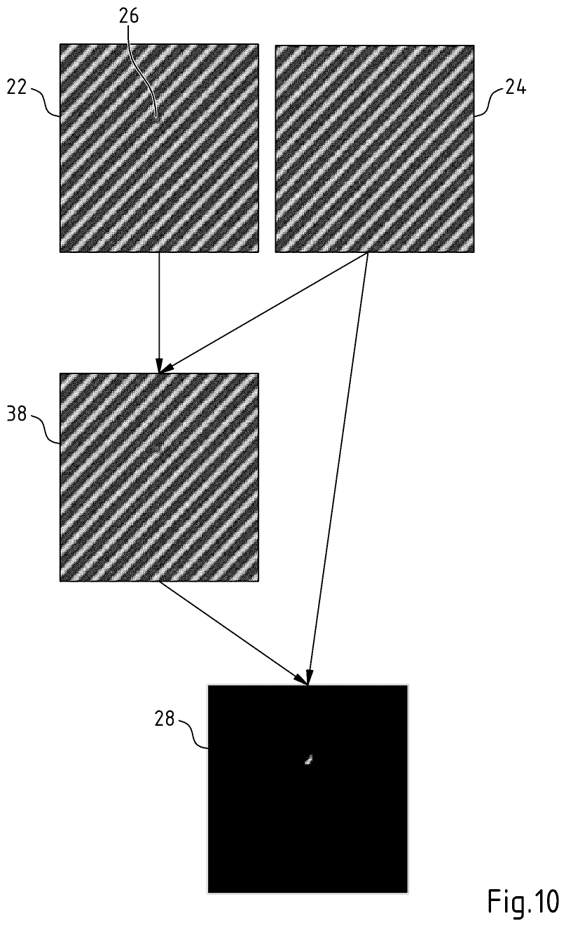

FIG. 9 illustrates an example of the third embodiment of the invention that is used to provide a fast and sub-pixel accurate alignment of the image 22 of the object and the reference image 24. The image 22 of the object shows a rectangle that is slightly displaced towards the upper right with respect to the reference image 24.

A preliminary alignment of the image 22 of the object and the reference image 24 is computed by applying a fast Fourier transform to the image 22 of the object and the reference image 24, thereby obtaining an image spectrum 40 and a reference spectrum 42.

In case the image 22 of the object is acquired by a mask inspection system, the accuracy of the alignment is negatively affected by noise, which partially originates in a frequency band, which does not contain optical information due to the limited imaging numerical aperture (NA). To improve the alignment accuracy, pure noise components can, optionally, be filtered from the image spectrum 40 and from the reference spectrum 42 using prior knowledge about the imaging settings of the mask inspection system. To this end, using a filter that is based on the physical shape of the imaging aperture adapted to the spectrum of the intensity, e.g., preserving the frequencies within 2·NA for a circular pupil, is used, thereby obtaining a filtered image spectrum 44 and a filtered reference spectrum 46. The filter depends on the physical shape of the imaging aperture, so it is not limited to a circular pupil. As the FFT of the image and the reference image is computed before anyway, this step requires only very little additional computation time.

The image spectrum and the reference spectrum can, optionally, be cropped by removing frequencies from the spectra, thereby leading to a cropped image spectrum 48 and a cropped reference spectrum 50. The removed frequencies can, for example, be the frequencies comprising the pure noise components as described in the previous paragraph. The size of the crop can be tailored to so-called magic FFT-numbers that allow for a particularly fast computation of subsequent Fourier transforms.

A cross-correlation 54 of the image 22 of the object and the reference image 24 is then obtained by computing the Hermitian product 52 of the image spectrum 40 and the reference spectrum 42 (optionally after filtering and/or cropping the image spectrum 40 and the reference spectrum 42 as described above) and the inverse FFT. A preliminary pixel-accurate alignment 58 of the image 22 of the object and the reference image 24 can then be obtained by computing the maximum of the cross-correlation. The preliminary alignment can be improved by fitting a function, e.g., a parabolic function, to the cross-correlation.

The image of the object can be acquired by an optical system, and prior knowledge about the optical system can be used to limit the search space. For example, prior knowledge about the stage accuracy could be used to define the search space, to add a penalty for large displacements when computing the maximum of the cross-correlation, or to add a hard constraint when computing the maximum of the cross-correlation.

Using the preliminary pixel-accurate alignment 58, a search space 60 is defined. The size of the search space 60 depends on the preliminary alignment accuracy. In order to obtain a sub-pixel displacement of the desired sub-pixel alignment accuracy, the cross-correlation, and thus also the search space 60, is upsampled to the desired sub-pixel alignment accuracy. The search space 60, thus, depends on the desired sub-pixel alignment accuracy. The maximum of the upsampled cross-correlation 56 is then the sub-pixel accurate displacement 62. The sub-pixel accurate displacement 62 can be improved by fitting a function, e.g., a parabolic function, to the upsampled cross-correlation 56 and finding the maximum of the fitted function. In this way, the accuracy of the maximum can be improved, e.g., by a factor of 100.

The computation of the cross-correlation within the search space, e.g., the upsampled cross-correlation, is carried out using a matrix-multiply discrete Fourier transform. An FFT is the most efficient approach when computation of all points of the upsampled cross-correlation is required. Unfortunately the FFT is restricted to computing the entire upsampled cross-correlation of the dimension of the image, resulting in an enormous waste of resources, since the upsampled cross-correlation 56 is only required within the search space 60, i.e., in a very small neighborhood about the initial estimate of the maximum of the cross-correlation 54 of the preliminary alignment. The advantage of a matrix-multiply discrete Fourier transform (DFT) results from the fact that an upsampled cross-correlation can be computed within just such a neighborhood without the need to zero-pad. Details on using a matrix-multiply discrete Fourier transform for image registration is described in the paper “Efficient subpixel image registration algorithms” by M. Guizar-Sicairos, S. Thurman and J. Fienup, Optics Letters, Vol. 33, No. 2, 2008. The upsampling of the cross-correlation 56 can be computed highly efficiently on a GPU if the number of samples, where the cross-correlation 56 is evaluated, is small, e.g., within a small search area around a given location.

The following improvements can be used with any of the methods according to the first or third embodiment of the invention:

To increase the accuracy of the alignment and to reduce the computation time, the computation of the alignment accuracy measure is restricted to non-homogeneous sections of the image of the object. As homogeneous regions do not contribute to improve the alignment accuracy, they can be ignored during image alignment. In this way, noise in the homogeneous regions does not influence the alignment accuracy measure.

Apart from non-homogeneous regions, the computation of the alignment accuracy measure can also be restricted to other regions, e.g., to regions of interest that can be defined by a user by selection or definition. For example, regions comprising features that can be aligned such as regions around design edges can be used as regions of interest. In this way, the computation times is further reduced and the accuracy is improved within the region of interest.

In an example, the method further comprises denoising the image of the object prior to the alignment. In this way, deviations from the reference image that are due to noise are reduced, which improves the alignment. In case the image of the object is acquired by a mask inspection system, pure noise components can be filtered from the spectrum of the image of the object and from the spectrum of the reference image using prior knowledge about the imaging settings of the mask inspection system. The imaging settings of the mask inspection system can comprise one or more of the group comprising the physical shape of the imaging aperture, the intensity spectrum of the incoming light, the numerical aperture of the mask inspection system, the pixel size. Apart from denoising, further pre-processing steps can be beneficial to improve the accuracy of the alignment, for example, further filtering operations, edge detection, contrast or brightness enhancement, tapering to avoid artifacts caused by periodic boundary conditions, etc.

In an example, the image 22 of the object 88 is acquired by an optical system, and prior knowledge about the optical system is used to limit the search space 60. If properties of the optical system are known, e.g., the stage accuracy, the search space can be limited, e.g., to a few pixels.

In an example, a coarse-to-fine image alignment is realized by iteratively applying the method steps for a sequence of increasing alignment accuracies ending with the desired sub-pixel alignment accuracy. Thus, the displacement is iteratively refined to obtain the optimal alignment. Increasing alignment accuracy here means that each subsequent alignment in the sequence is more accurate than the previous alignment-therefore, the maximum alignment error decreases over the sequence. For an example with a preliminary alignment accuracy of 1 px and a desired sub-pixel alignment accuracy of 0.2 px, a sequence of increasing alignment accuracies could be, for example, [0.5 px; 0.2 px] or [0.8 px; 0.6 px; 0.4 px; 0.2 px].

In case of a higher preliminary alignment accuracy above one pixel, e.g., of three or five pixels, the alignment can be carried out by first using integer valued alignment accuracies, e.g., 1 px, and subsequently using sub-pixel alignment accuracies, e.g., 0.2 px. To this end, according to an example, the sequence of increasing alignment accuracies consists of two consecutive sections, wherein the first section consists of one or more integer values and the second section consists of one or more sub-pixel values. For example, in case of a preliminary alignment accuracy of 3 px and a desired sub-pixel alignment accuracy of 0.2 px, the sequence of increasing alignment accuracies could be [1 px; 0.2 px], that consists of a first section containing an integer alignment accuracy of 1 px and a second section containing a sub-pixel alignment accuracy of 0.2 px (the desired sub-pixel alignment accuracy). An alternative sequence of alignment accuracies could be [2 px; 1 px; 0.5 px; 0.2 px]. In case the preliminary alignment accuracy is above one pixel, the sequence of increasing alignment accuracies can contain an alignment accuracy of 1 px. For example, the two example sequences before contain a 1 px alignment accuracy before the desired sub-pixel alignment accuracy of 0.2 px.

For methods according to the third embodiment of the invention, a better convergence order in terms of DFT upsample function calls can be achieved by a coarse-to-fine approach comprising iteratively upsampling the cross-correlation by a fixed factor, e.g., 10, and selecting a smaller search area based on the determined maximum and upsampling the selected search area only. In this way, an accuracy of at least 0.0001 px can be achieved.

The computation time can also be reduced by batch-processing, i.e., by simultaneous processing of multiple images or image sections due to a better GPU utilization.

The method according to the third embodiment of the invention allows for a registration of 512×512 px sized images using a single A100 GPU within 0.1 ms and is, thus, very fast compared to state of the art registration methods. In fact, in most cases, the approach is about a factor of 3-4 times faster than gradient-based approaches that are based on automatic differentiation. At the same time it offers further advantages, e.g., a fixed runtime, no risk of getting trapped in local minima (even on an upsampled pixel level), simultaneous application to multiple images is possible (“batching”), etc.

In an example, the preliminary alignment accuracy and/or the desired sub-pixel alignment accuracy of the image of the object can differ within each dimension of the image. In particular, the desired sub-pixel alignment accuracy can be lower in a dimension of the image of the object that contains smaller structures than the other(s), that is of more interest to a user than the other(s), or in case the image of the object is acquired using anamorphotic optics. A preliminary alignment accuracy in one dimension can also differ from the preliminary alignment accuracy in one or more other dimensions, e.g., in case displacements only occur in one dimension of the image.

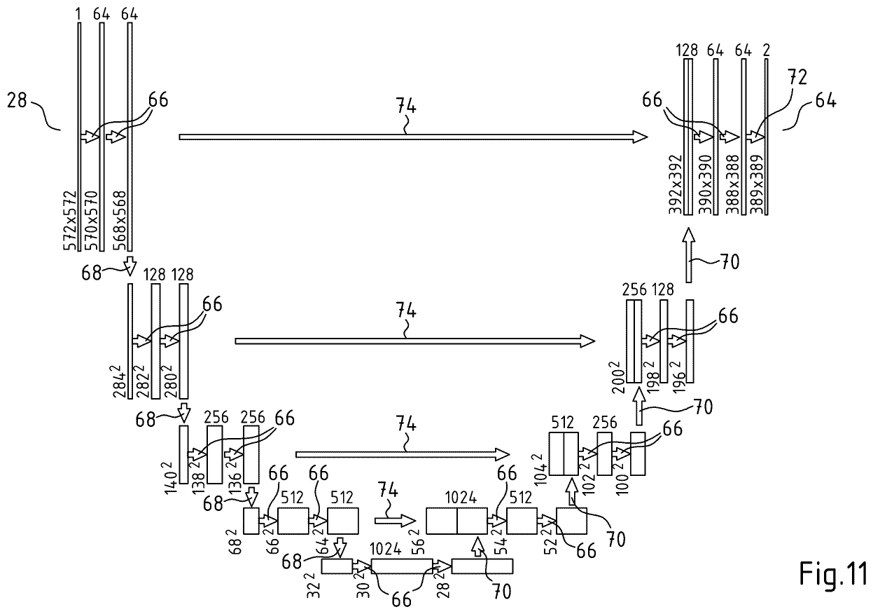

According to a fourth embodiment of the invention illustrated in FIG. 10, the aligned image 38 of the object that is computed using any of the methods according to the first or third embodiment of the invention is used for defect detection. The aligned image 38 is used for defect detection by computationally comparing the aligned image 38 of the object with the reference image 24, e.g., by computing a difference image 28 or by applying a neural network that is trained to detect defects as described with respect to FIG. 11, and by marking deviations as defects 26. The difference image 28 only contains deviations originating from the defect 26 in the image and no deviations due to alignment accuracies. Thus, using the aligned image 38 defects 26 can be detected with an increased accuracy.

From the difference image 28 defects 26 can be detected in various ways. For example, one or more thresholds or adaptive thresholds can be applied to detect defects in the image of the object. In another example, trained machine learning methods are used to detect defects in the difference image.

In an example, the U-Net illustrated in FIG. 11 is used for defect detection in the difference image. The difference image 28 is used as input, and the U-Net returns a defect probability map 64 as output. The operations within each layer are indicated in the following table

| | |
|---|---|
| 66 | Conv 3 × 3, ReLU |
| 68 | Max pool 2 × 2 |
| 70 | Up-conv 2 × 2 |
| 72 | Conv 1 × 1 |
| 74 | Copy and crop |

An exemplary training of this U-Net can be carried out as follows: the training data comprises 100,000 crops of size 512×512 of difference images 28 containing various integrated circuit patterns such as lines and spaces, holes, pin dots or logic patterns. The training data is augmented by random cropping to the size 256×256. For optimization, AdamW is used for 100 epochs with a batch size of 32, a learning rate of 5e-4 with a decay of 0.98 in each epoch. A log-weighted cross entropy loss is used as loss function. The U-Net contains a single channel input (the difference image). Alternatively, the aligned image of the object and the reference image could be used as input. The depth of the U-Net is three for the encoder and decoder part. 32 filters are initially used and a 2D batch norm. The output of the U-Net is a single channel defect probability map 64.

A connected component analysis could be applied to the defect probability map 64 to obtain defect pixel clusters. Finally, cluster centers and/or defect scores could be computed for each of the clusters, e.g., by computing the centroid or mean coordinate and an average or maximum defect probability of each cluster.

In order to save computation time and resources, the method for detecting defects can further comprise determining a defect likelihood for a defect being present in the image of the object using the alignment accuracy measure, and, in case the defect likelihood is below a threshold, skipping step ii.) Thus, depending on the alignment accuracy measure, e.g., on the cross-correlation result, it is determined if a defect detection is required at all. To this end, a threshold can, for example, be defined for the alignment accuracy measure, and if the alignment accuracy measure exceeds or falls below the threshold indicating a very high alignment accuracy, the defect detection is skipped. A very high alignment accuracy measure can, in fact, justify the assumption that no defects are present in the image of the object.

In some implementations, after the defects are found using any of the methods described above, the object can be modified to repair or eliminate the defects. Repairing the defects can include, e.g., depositing materials on a photolithography mask, wafer or reticle using a deposition process, or removing materials from a photolithography mask, wafer or reticle using an etching process. In addition or alternatively, the quality of the object can be assessed with respect to the detected defects. Based on the quality assessment, a decision can be taken to repair or discard the object.

In some implementations, the information about the defects serves as feedback to improve the process parameters of the manufacturing process, e.g., exposure time, focus, the etching or deposition process, etc. For example, after the defects are identified from a first object or first batch of objects, the process parameters of the manufacturing process are modified to reduce defects in a second object or a second batch of objects.

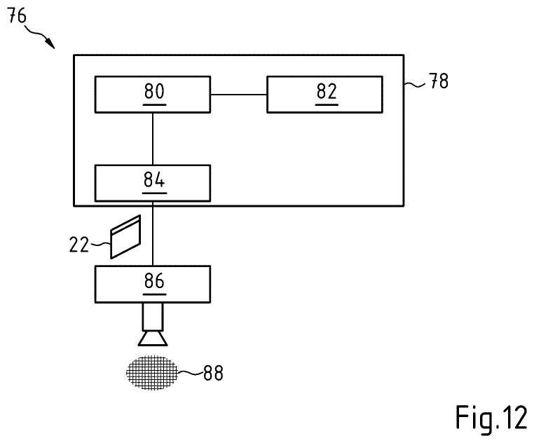

A system 76 according to a seventh embodiment of the invention is illustrated in FIG. 12. The system 76 comprises: an image acquisition system 86 such as the optical systems 10, 10′ in FIG. 1 or FIG. 2, configured to provide an image 22 of the object 88 comprising integrated circuit patterns, e.g., of wafers, photolithography masks or reticles; one or more processing devices 80; one or more machine-readable hardware storage devices 82 comprising instructions that are executable by one or more processing devices 80 to perform operations comprising any one of the methods of the first, second, third or fourth embodiment of the invention described above, e.g., for aligning an image to a reference image or for detecting defects in an image 22 of an object comprising integrated circuit patterns.

The image acquisition system 86 provides the image 22 to a data analysis device 78. The image acquisition system 86 can comprise an optical system 10, 10′. The one or more processing devices 80 can be implemented, e.g., as a central processing unit (CPU), graphics processing unit (GPU or tensor processing unit (TPU). The one or more processing devices 80 can receive the image 22 via an interface 84. The one or more processing devices 80 can load program code from a memory, e.g., program code for aligning an image to a reference image, for detecting defects, for controlling at least one object manufacturing process parameter, or for modifying the object to at least one of reduce, repair, or remove at least one defect, by executing a method according to any of the embodiments of the invention as described above. The one or more processing devices 80 can execute the program code.

In some implementations, each of the one or more processing devices can include one or more processor cores, and each processor core can include logic circuitry for processing data. For example, a processor can include an arithmetic and logic unit (ALU), a control unit, and various registers. Each processor can include cache memory. Each processor can include a system-on-chip (SoC) that includes multiple processor cores, random access memory, graphics processing units, one or more controllers, and one or more communication modules. Each processor can include millions or billions of transistors.

In some implementations, the one or more processing devices can include one or more computers, each computer can include one or more data processors for processing data. The one or more machine-readable hardware storage devices can store one or more computer programs including instructions that when executed by the one or more computers cause the one or more computers to carry out the processes described above. The one or more processing devices can include one or more input devices, such as a keyboard, a mouse, a touchpad, and/or a voice command input module, and one or more output devices, such as a display, and/or an audio speaker.

In some implementations, the one or more processing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Embodiments, examples and aspects of the invention can be described using the following clauses:
1. A computer implemented method 30, 30′, 30″ for providing a fast sub-pixel alignment of an image 22 of an object 88 comprising integrated circuit patterns with a reference image 24, the method comprising:
   a. Defining a search space 60 comprising potential displacements 34 between the image 22 of the object 88 and the reference image 24, wherein the search space 60 depends on a preliminary alignment accuracy and a desired sub-pixel alignment accuracy;
   b. Aligning the image 22 of the object 88 with the reference image 24 by finding a potential displacement 34 between the image 22 of the object 88 and the reference image 24 within the search space 60 that optimizes an alignment accuracy measure.
2. The method of clause 1, wherein the alignment accuracy measure evaluates the alignment accuracy between a displaced image 32 for a potential displacement within the search space 60 and the reference image 24, and wherein the displaced image 32 is computed by defining a corresponding convolution kernel that realizes the potential displacement 34 of the image 22 of the object 88 and by convolving the image 22 of the object 88 with the convolution kernel,
or
wherein the alignment accuracy measure evaluates the alignment accuracy between the image 22 of the object 88 and a displaced image 32 for a potential displacement within the search space 60, and wherein the displaced image 32 is computed by defining a corresponding convolution kernel that realizes the potential displacement 34 of the reference image 24 and by convolving the reference image 24 with the convolution kernel.
3. The method of clause 2, wherein the size of the convolution kernel depends on the preliminary alignment accuracy.
4. The method of clause 2 or 3, wherein at least one convolution kernel is separated into lower dimensional convolution kernels, and wherein the displaced image 32 is obtained by convolving the image 22 of the object 88 or the reference image 24 successively with the lower dimensional convolution kernels.
5. The method of any one of the preceding clauses, wherein the potential displacements 34 form a regular grid 35 in the search space 60.
6. The method of any one of the preceding clauses, wherein the number of potential displacements 34 in the search space 60 is inversely proportional to the desired sub-pixel alignment accuracy.
7. The method of any one of clauses 2 to 6, wherein the displaced images 34 are computed using one or more hardware acceleration devices.
8. The method of clause 1, wherein the alignment accuracy measure comprises a cross-correlation 54 between the image 22 of the object 88 and the reference image 24.
9. The method of clause 8, wherein the alignment accuracy measure comprises a weighted spectral cross-correlation.
10. The method of clause 9, wherein the weighted spectral cross-correlation is weighted with the inverse of its magnitude to the power of a value within the interval [0,1].
11. The method of clause 8 or 9, wherein the alignment accuracy measure comprises a phase correlation.
12. The method of any one of clauses 8 to 11, wherein the cross-correlation 54 is upsampled within the search space 60 using a matrix-multiply discrete Fourier transform.
13. The method of any one of clauses 8 to 12, wherein the optimum of the alignment accuracy measure is refined by fitting a function to the alignment accuracy measure and determining its optimum.
14. The method of any one of clauses 8 to 13, wherein the alignment accuracy measure is computed using one or more hardware acceleration devices.
15. The method of any one of the preceding clauses, wherein the computation of the alignment accuracy measure is restricted to non-homogeneous sections of the image 22 of the object 88.
16. The method of any one of the preceding clauses, wherein the preliminary alignment accuracy and the search space 60 in step i. are defined with respect to a preliminary alignment of the image 22 of the object 88 and the reference image 24.
17. The method of clause 16, wherein the preliminary alignment accuracy is one pixel.
18. The method of clause 16 or 17, wherein the preliminary alignment is obtained by maximizing a cross-correlation 54 that is obtained by applying an inverse fast Fourier transform to a Hermitian product 52 of the image spectrum 40 and the reference spectrum 42.
19. The method of any one of the preceding clauses, wherein a coarse-to-fine image alignment is realized by iterating the method steps for a sequence of increasing alignment accuracies ending with the desired sub-pixel alignment accuracy.
20. The method of clause 19, wherein, in case the preliminary alignment accuracy is above one pixel, the sequence of increasing alignment accuracies consists of two consecutive sections, wherein the first section consists of one or more integer values and the second section consists of one or more sub-pixel values.
21. The method of clause 19 or 20, wherein, in case the preliminary alignment accuracy is above one pixel, the sequence of alignment accuracies contains an alignment accuracy of one pixel.
22. The method of any one of the preceding clauses, further comprising denoising the image 22 of the object 88.
23. The method of any one of the preceding clauses, wherein the image 22 of the object 88 is acquired by an optical system, and wherein pure noise components are filtered from the spectrum 40 of the image of the object and from the spectrum 42 of the reference image using prior knowledge about the imaging settings of the optical system.
24. The method of clause 23, wherein the imaging settings of the optical system comprise one or more of the group comprising the physical shape of the imaging aperture, the intensity spectrum of the incoming light, the numerical aperture of the optical system, the pixel size.
25. The method of any one of the preceding clauses, wherein the image 22 of the object 88 is acquired by an optical system, and wherein prior knowledge about the optical system is used to limit the search space 60.
26. The method of any one of the preceding clauses, wherein the preliminary alignment accuracy is above or equal to one pixel.
27. A method for detecting defects 26 in an image 22 of an object 88 comprising integrated circuit patterns, the method comprising:
   i.) Aligning the image 22 of the object 88 with a reference image 24 using a method according to any one of the preceding clauses;
   ii.) Computationally comparing the aligned image 38 of the object 88 with the reference image 24 and marking deviations as defects 26.
28. The method of clause 27, further comprising determining a defect likelihood for a defect being present in the image 22 of the object 88 using the alignment accuracy measure, and, in case the defect likelihood is below a threshold, skipping step ii.
29. The method of clause 27 or 28, further comprising controlling at least one object manufacturing process parameter based on one or more measurements of the defects 26.
30. The method of clause 27 or 28, further comprising modifying the object 88 to at least one of reduce, repair, or remove at least one defect 26.
31. The method of any one of the preceding clauses, wherein the object 88 comprises at least one of a photolithography mask, a reticle, or a wafer.
32. A computer-readable medium, on which a computer program executable by a computing device is stored, the computer program comprising code for executing a method of any one of the preceding clauses.
33. A computer program product comprising instructions which, when the program is executed by a computer, cause the computer to carry out a method of any one of the preceding method clauses.
34. A system 76 comprising:
   an image acquisition system 86 configured to provide an image 22 of the object 88 comprising integrated circuit patterns;
   one or more processing devices 80;
   one or more machine-readable hardware storage devices 82 comprising instructions that are executable by one or more processing devices 80 to perform operations comprising the method of any one of the method clauses.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment”, “according to an example” or “according to an aspect” in various places throughout this specification are not necessarily all referring to the same embodiment, example or aspect, but may refer to different embodiments, examples, or aspects. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

In a general aspect, the invention relates to a computer implemented method for providing a fast sub-pixel alignment of an image 22 of an object 88 comprising integrated circuit patterns with a reference image 24, the method comprising: defining a search space 60 comprising potential displacements 34 between the image 22 of the object 88 and the reference image 24, wherein the search space 60 depends on a preliminary alignment accuracy and a desired sub-pixel alignment accuracy; aligning the image 22 of the object 88 with the reference image 24 by finding a potential displacement 34 between the image 22 of the object 88 and the reference image 24 within the search space 60 that optimizes an alignment accuracy measure. The invention further relates to a corresponding system.

### REFERENCE NUMBER LIST

10, 10′ Optical system
12 Light source
14 Object comprising integrated circuit patterns
16 Illumination optics
17 Projection optics
18 Wafer plane
19 Projection section
20 Image sensor
22 Image
24 Reference image
26 Defect
28 Difference image
30, 30′, 30″ Computer implemented method
32 Displaced image
34 Potential displacement
35 Regular grid
36 Alignment accuracy measure
38 Aligned image
40 Image spectrum
42 Reference spectrum
44 Filtered image spectrum
46 Filtered reference spectrum
48 Cropped image spectrum
50 Cropped reference spectrum
52 Hermitian product
54 Cross-correlation
56 Upsampled cross-correlation
58 Pixel-accurate displacement
60 Search space
62 Sub-pixel accurate displacement
64 Defect probability map
66 Conv 3×3 ReLU
68 Max pool 2×2
70 Up-conv 2×2
72 Conv 1×1
74 Copy and crop
76 System
78 Data analysis device
80 Processing device
82 Hardware storage device
84 Interface
86 Image acquisition system
88 Object

What is claimed is:

1. A computer implemented method for providing a fast sub-pixel alignment of an image of an object comprising integrated circuit patterns with a reference image, the method comprising:
a. defining a search space comprising potential displacements between the image of the object and the reference image, wherein the search space depends on a preliminary alignment accuracy and a desired sub-pixel alignment accuracy; and
b. aligning the image of the object with the reference image by finding a potential displacement between the image of the object and the reference image within the search space that optimizes an alignment accuracy measure.

2. The method of claim 1, wherein the alignment accuracy measure evaluates the alignment accuracy between a displaced image for a potential displacement within the search space and the reference image, and wherein the displaced image is computed by defining a corresponding convolution kernel that realizes the potential displacement of the image of the object and by convolving the image of the object with the convolution kernel,
or
wherein the alignment accuracy measure evaluates the alignment accuracy between the image of the object and a displaced image for a potential displacement within the search space, and wherein the displaced image is computed by defining a corresponding convolution kernel that realizes the potential displacement of the reference image and by convolving the reference image with the convolution kernel.

3. The method of claim 2, wherein the size of the convolution kernel depends on the preliminary alignment accuracy.

4. The method of claim 2, wherein at least one convolution kernel is separated into lower dimensional convolution kernels, and wherein the displaced image is obtained by convolving the image of the object or the reference image successively with the lower dimensional convolution kernels.

5. The method of claim 1, wherein the potential displacements form a regular grid in the search space.

6. The method of claim 1, wherein the number of potential displacements in the search space is inversely proportional to the desired sub-pixel alignment accuracy.

7. The method of claim 2, wherein the displaced images are computed using one or more hardware acceleration devices.

8. The method of claim 1, wherein the alignment accuracy measure comprises a cross-correlation between the image of the object and the reference image.

9. The method of claim 8, wherein the alignment accuracy measure comprises a weighted spectral cross-correlation.

10. The method of claim 9, wherein the weighted spectral cross-correlation is weighted with the inverse of its magnitude to the power of a value within the interval [0,1].

11. The method of claim 8, wherein the alignment accuracy measure comprises a phase correlation.

12. The method of claim 8, wherein the cross-correlation is upsampled within the search space using a matrix-multiply discrete Fourier transform.

13. The method of claim 8, wherein the optimum of the alignment accuracy measure is refined by fitting a function to the alignment accuracy measure and determining its optimum.

14. The method of claim 8, wherein the alignment accuracy measure is computed using one or more hardware acceleration devices.

15. The method of claim 1, wherein the computation of the alignment accuracy measure is restricted to non-homogeneous sections of the image of the object.

16. The method of claim 1, wherein the preliminary alignment accuracy and the search space in step a. are defined with respect to a preliminary alignment of the image of the object and the reference image.

17. The method of claim 16, wherein the preliminary alignment accuracy is one pixel.

18. The method of claim 16, wherein the preliminary alignment is obtained by maximizing a cross-correlation that is obtained by applying an inverse fast Fourier transform to a Hermitian product of the image spectrum and the reference spectrum.

19. The method of claim 1, wherein a coarse-to-fine image alignment is realized by iterating the method steps for a sequence of increasing alignment accuracies ending with the desired sub-pixel alignment accuracy.

20. The method of claim 19, wherein, in case the preliminary alignment accuracy is above one pixel, the sequence of increasing alignment accuracies consists of two consecutive sections, wherein the first section consists of one or more integer values and the second section consists of one or more sub-pixel values.

21. The method of claim 19, wherein, in case the preliminary alignment accuracy is above one pixel, the sequence of alignment accuracies contains an alignment accuracy of one pixel.

22. The method of claim 1, further comprising denoising the image of the object.

23. The method of claim 1, wherein the image of the object is acquired by an optical system, and wherein pure noise components are filtered from the spectrum of the image of the object and from the spectrum of the reference image using prior knowledge about the imaging settings of the optical system.

24. The method of claim 23, wherein the imaging settings of the optical system comprise one or more of the group comprising the physical shape of the imaging aperture, the intensity spectrum of the incoming light, the numerical aperture of the optical system, the pixel size.

25. The method of claim 1, wherein the image of the object is acquired by an optical system, and wherein prior knowledge about the optical system is used to limit the search space.

26. The method of claim 1, wherein the preliminary alignment accuracy is above or equal to one pixel.

27. A method for detecting defects in an image of an object comprising integrated circuit patterns, the method comprising:
i.) aligning the image of the object with a reference image using a method according to claim 1;
ii.) computationally comparing the aligned image of the object with the reference image and marking deviations as defects.

28. The method of claim 27, further comprising determining a defect likelihood for a defect being present in the image of the object using the alignment accuracy measure, and, in case the defect likelihood is below a threshold, skipping step b.).

29. The method of claim 27, further comprising controlling at least one object manufacturing process parameter based on one or more measurements of the defects.

30. The method of claim 27, further comprising modifying the object to at least one of reduce, repair, or remove at least one defect.

31. The method of claim 1, wherein the object comprises at least one of a photolithography mask, a reticle, or a wafer.

32. A computer-readable medium, on which a computer program executable by a computing device is stored, the computer program comprising code for executing a method of claim 1.

33. A computer program product comprising instructions which, when the program is executed by a computer, cause the computer to carry out a method of claim 1.

34. A system comprising:
an image acquisition system configured to provide an image of the object comprising integrated circuit patterns;
one or more processing devices;
one or more machine-readable hardware storage devices comprising instructions that are executable by one or more processing devices to perform operations comprising the method of claim 1.
